(19) United States
(12) Patent Application Publication
(10) Pub. No.: US 2026/0301611 A1
(43) Pub. Date: Oct. 1, 2026

(54) SPLICING DISPLAY APPARATUS AND LIGHT-EMITTING MODULE

(71) Applicant: TCL CHINA STAR OPTOELECTRONICS TECHNOLOGY CO., LTD., Shenzhen, Guangdong (CN)

(72) Inventors: Pengfei WEI, Shenzhen, Guangdong (CN); Hongyuan XU, Shenzhen, Guangdong (CN); Feng ZHENG, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 19/475,583

(22) PCT Filed: Jan. 15, 2024
(86) PCT No.: PCT/CN2024/072228

§ 371 Date: Oct. 15, 2025

(30) Foreign Application Priority Data
Dec. 7, 2023 (CN) 202311685712.7
Jan. 8, 2024 (CN) 202410034309.6

(51) Int. Cl. G09F 9/302

(52) U.S. Cl. CPC G09F 9/3026

(57) ABSTRACT

The present disclosure provides a splicing display apparatus and a light-emitting module. The splicing display apparatus includes at least two display devices, a supplementary lighting assembly, and an adapter bracket. The adapter bracket is located on a back-light side of each of the two adjacent display devices, and a part of the adapter bracket extends into the splicing gap. The adapter bracket is detachably connected with at least one of the two adjacent display devices. The supplementary lighting assembly is positioned separatable from the adapter bracket, and separably positioning parts of the adapter bracket and the supplementary lighting assembly are located in an orthographic projection of a plane where the splicing gap is located.

### TECHNICAL FIELD

The present disclosure relates to the field of display technologies, and in particular, to a splicing display apparatus and a light-emitting module.

### BACKGROUND

At present, in order to achieve large-sized display of display devices, display splicing technology is rapidly developing. However, due to problems such as cost and reliability, the splicing devices for organic light-emitting diode (OLED) display panels and micro-diode direct display panels cannot be widely promoted, making the splicing devices for liquid crystal display (LCD) panels are still mainstream products in the market.

In an existing splicing device, a supplementary lighting structure is generally provided between two spliced display devices to eliminate a splicing gap between the spliced display devices. However, but the maintenance and installation of a light bar in the existing supplementary lighting structure is relatively difficult.

### SUMMARY

The present disclosure provides a splicing display apparatus and a light-emitting module to improve the problem of difficult installation and maintenance of a light bar at a splicing gap in existing splicing display apparatuses.

To solve the above problems, the present disclosure provides the following technical proposals.

The present disclosure provides a splicing display apparatus, including:

at least two display devices, a splicing gap being formed between two adjacent display devices of the display devices;

an adapter bracket located on a back-light side of each of the two adjacent display devices, and the adapter bracket being configured to be detachably connected to at least one of the two adjacent display devices; and

a supplementary lighting assembly configured to be positioned separatable from the adapter bracket. The supplementary lighting assembly includes a light bar located on a light-emitting side of each of the two adjacent display devices, and the light bar covers the splicing gap.

A plurality of light-emitting elements are provided on a side of the light bar facing the light-emitting side, a plurality of driving chips are provided on a side of the light bar facing away from the light-emitting side, and separably positioning parts of the adapter bracket and the supplementary lighting assembly are located in an orthographic projection of a plane where the splicing gap is located.

The present disclosure also provides a light-emitting module, including an adapter bracket and a supplementary lighting assembly. The supplementary lighting assembly is positioned separatable from the adapter bracket, and the supplementary lighting assembly includes:

a light bar including a light-emitting surface;

an adapter plate fixed on a side of the adapter bracket away from the light-emitting surface;

a first connector provided on a side of the light bar facing away from the light-emitting surface; and a second connector provided on a side of the adapter plate facing the light-emitting surface. The first connector and the second connector are configured to be detachably connected with each other.

A plurality of light-emitting elements are provided on a side of the light bar facing the light-emitting surface, and a plurality of driving chips are provided on a side of the light bar facing away from the light-emitting surface.

### BRIEF DESCRIPTION OF DRAWINGS

FIG. 1 is a structural view of a splicing display apparatus of the present disclosure from a light-emitting side.

FIG. 2 is a structural view of a splicing display apparatus of the present disclosure from a back-light side.

FIG. 3 is a structural view of a light-emitting module of a splicing display apparatus of the present disclosure.

FIG. 4 is a first structural view of a light-emitting module of a splicing display apparatus of the present disclosure.

FIG. 5 is an exploded view of the light-emitting module in FIG. 4.

FIG. 6 is a second structural view of a light-emitting module of a splicing display apparatus of the present disclosure.

FIG. 7 is a structural view of a light bar of a light-emitting module of the present disclosure.

FIG. 8 is a third structural view of a light-emitting module of a splicing display apparatus of the present disclosure.

FIG. 9 is an exploded view of the light-emitting module in FIG. 8.

FIG. 10 is a fourth structural view of a light-emitting module of a splicing display apparatus of the present disclosure.

FIG. 11 is a fifth structural view of a light-emitting module of a splicing display apparatus of the present disclosure.

FIG. 12 is a partial cross-sectional view of a cross-section AA in FIG. 1.

FIG. 13 is a first cross-sectional view of a cross-section BB in FIG. 1.

FIG. 14 is a second cross-sectional view of a cross-section BB in FIG. 1.

FIG. 15 is a partially enlarged view of a light-emitting module and a display device in a splicing display apparatus of the present disclosure.

FIG. 16 is a schematic diagram of film layers in a splicing display apparatus of the present disclosure.

### EMBODIMENTS OF THE INVENTION

The technical proposals in the embodiments of the present disclosure will be clearly and completely described with reference to the accompanying drawings in the embodiments of the present disclosure. Apparently, the described embodiments are merely some embodiments of the present disclosure instead of all embodiments. Based on the embodiments of the present disclosure, all other embodiments obtained by those skilled in the art without creative effort fall within the protection scope of the present disclosure. In addition, it should be understood that specific embodiments described herein are only used to explain and illustrate the present disclosure and are not intended to limit the present disclosure. In the present disclosure, unless otherwise specified, orientational terms used, such as “upper” and “lower”, generally refer to upper and lower positions of a device in actual use or working state, and specifically orientations in the drawings, while the terms “inside” and “outside” refer to a position relative to an outline of the device.

In the existing splicing device, a light bar is generally arranged between two display devices to eliminate a splicing gap between the spliced display devices, but the maintenance and installation of an existing supplementary lighting structure is relatively difficult. The present disclosure proposes the following technical proposals to solve the above-mentioned technical problems.

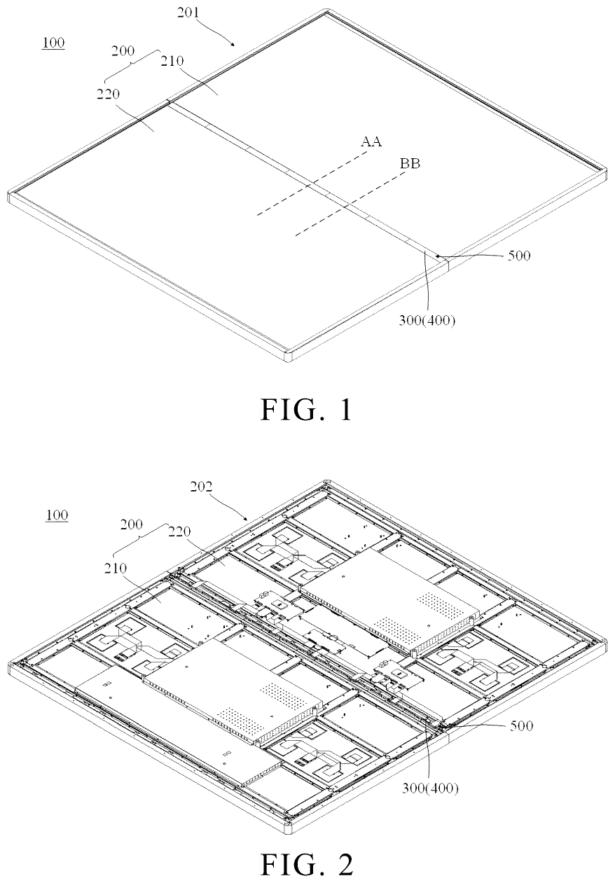

Referring to FIG. 1 to FIG. 16, the present disclosure provides a splicing display apparatus 100, which includes at least two display devices 200, a supplementary lighting assembly 300, and an adapter bracket 400. A splicing gap 500 is formed between two adjacent display devices 200. The adapter bracket 400 may be located on a back-light side 202 of each of the two adjacent display devices 200, and a part of the adapter bracket 400 extends into the splicing gap 500. The supplementary lighting assembly 300 is positioned separatable from the adapter bracket 400, and the adapter bracket 400 is connected to at least one of the two adjacent display devices 200.

In the embodiments, the display device 200 may be an LCD display device, a Mini LED display device, a Micro LED display device, or other light-emitting display device.

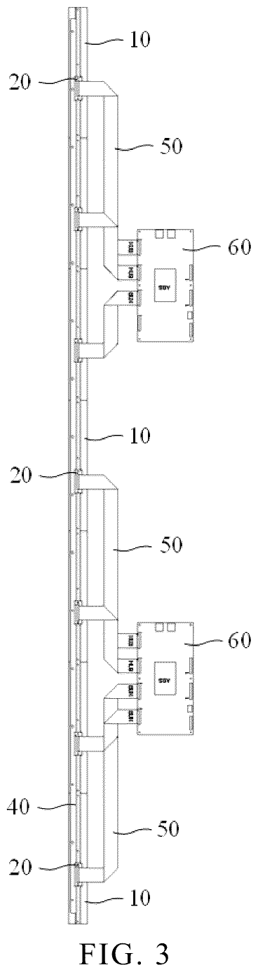

Referring to FIG. 3, the supplementary lighting assembly 300 may include one or more light bars 10 located on a light-emitting side 201 of each of the two adjacent display devices 200. Both sides of the light bar 10 overlap with the two adjacent display devices 200, respectively, and cover at least a part of the splicing gap 500. At the same time, a plurality of driving chips 120 are provided on a side of the light bar 10 facing away from the light-emitting side 201, a a plurality of light-emitting elements are provided on a side of the light bar 10 facing the light-emitting side 201, and the driving chips 120 are configured to control the plurality of light-emitting elements. Separably positioning parts of the adapter bracket 400 and the supplementary lighting assembly 300 are located in an orthographic projection of a plane where the splicing gap 500 is located.

In the present disclosure, the adapter bracket 400 is provided on the back-light side 202 of one of the two adjacent display devices 200, and the supplementary lighting assembly 300 provided with the driving chips 120 is positioned separatable from the adapter bracket 400, so that the light bar 10 in the supplementary lighting assembly can be positioned separatable from the adapter bracket 400, simplifying the installation and disassembly of the light bar 10, and facilitating the pre-maintenance of the light bar 10 integrated with both the lamp and the driver.

It should be noted that the supplementary lighting assembly 300 may also include one or more adapter plates 20, one or more first transmission members 30, and one or more second transmission members 50 connected to each other. The first transmission member 30 is located in the splicing gap 500. A first end of the first transmission member 30 is electrically connected to the side of the light bar facing away from the light-emitting side, and a second end of the first transmission member 30 extends toward the back-light side 202 and passes through the splicing gap 500. The adapter plate 20 is fixed to the side of the adapter bracket 400 away from the light-emitting side 201. The second transmission member 50 is located on the back-light side 202 of each of the two adjacent display devices 200, and a first end of the second transmission member 50 and the adapter plate 20 are detachably connected with each other.

It should be noted that a number of the display devices 200 may be 2 n, such as the 1×2 splicing display apparatus 100 illustrated in FIG. 1, there is one splicing gap 500 between two adjacent display devices 200, and the supplementary lighting assembly 300 is configured to eliminate the splicing gap 500 between the two adjacent display devices 200. Alternatively, in the 2×2 splicing display apparatus 100, four display devices 200 are spliced, and there are four splicing gaps 500 between the four display devices 200, and one supplementary lighting assembly 300 needs to be provided in each of the four splicing gaps 500. In the following embodiments, the technical proposals of the present disclosure will be described with reference to the 1×2 splicing display apparatus 100 illustrated in FIG. 1 and FIG. 2.

It should be noted that, as illustrated in FIG. 1 and FIG. 2, in the present disclosure, seven light bars 10 may be provided between the two adjacent display devices 200. Each light bar 10 is provided with one first connector 310, one light bar 10 corresponds to one adapter plate 20, one adapter plate 20 is connected to one second transmission member 50, and four second transmission members 50 are connected to the same controller 60. For example, in the structure illustrated in FIG. 3, four second transmission members 50 are connected to the same controller 60, and the other three second transmission members 50 are connected to another controller 60. When a length of the splicing gap 500 is small, fewer light bars 10 may be provided, and the number of the light bars 10 is mainly determined according to the length of the splicing gap 500 and the length of the light bars 10 themselves.

It should be noted that light-emitting elements provided on the light bar 10 may be conventional LEDs, Mini LEDs, or Micro LEDs, and according to the size and resolution of the splicing display apparatus 100, the LEDs with corresponding sizes can be set. The light-emitting elements may be LED elements emitting red, green, and blue light.

It should be noted that, as illustrated in FIG. 3, the supplementary lighting component 300 further includes one or more controllers 60, and the controller 60 may be a hub. The controller 60 may be fixed to the back-light side 202 of one of two adjacent display devices 200, and a second end of the second transmission member 50 is electrically connected to the controller 60.

It should be noted that, to enhance the structural strength of the adapter bracket 400, a number of the adapter brackets 400 between two adjacent display devices 200 may be one. The one adapter bracket 400 can carry a plurality of light bars 10, and the adapter bracket 400 does not require splicing.

It should be noted that the adapter bracket 400 in the present disclosure may be detachably connected with the display devices 200.

It should be noted that in the present disclosure, a length direction of the light bar 10 is defined as an X direction, a width direction of the light bar 10 is defined as a Y direction, and a thickness direction of the light bar 10 is defined as a Z direction.

Technical proposals of the present disclosure are now described in connection with specific embodiments.

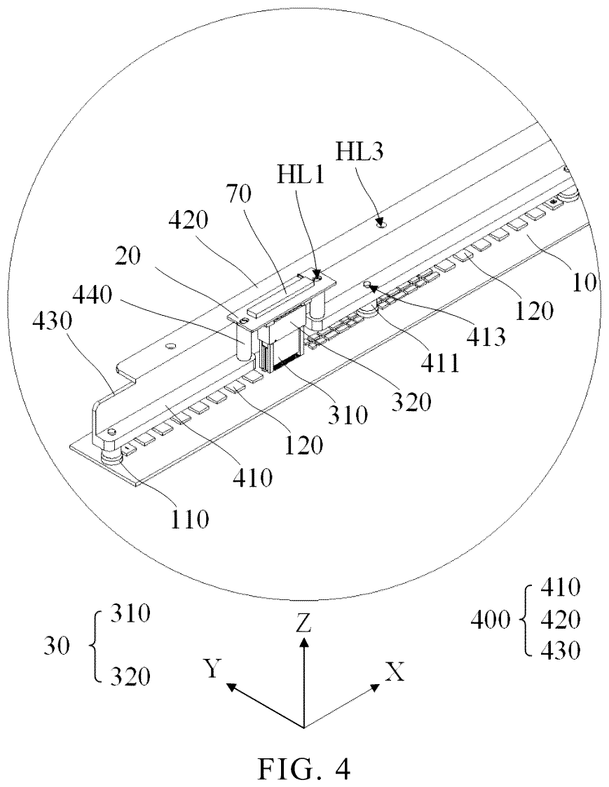

In the splicing display apparatus 100 of the present disclosure, referring to FIG. 4 to FIG. 6 and FIG. 9 to FIG. 11, the supplementary lighting assembly 300 further includes at least two connecting members 110 provided on the side of the light bars 10 facing away from the light-emitting side 201. The at least two connecting members 110 are arranged in the length direction of the light bar 10, the connecting members 110 are positioned separatable from the adapter bracket 400, and the at least two connecting members 110 are located in the splicing gap 500.

In the embodiments, the adapter bracket 400 may include a top plate 410, and the at least two connecting members 110 are positioned separatable from the top plate 410.

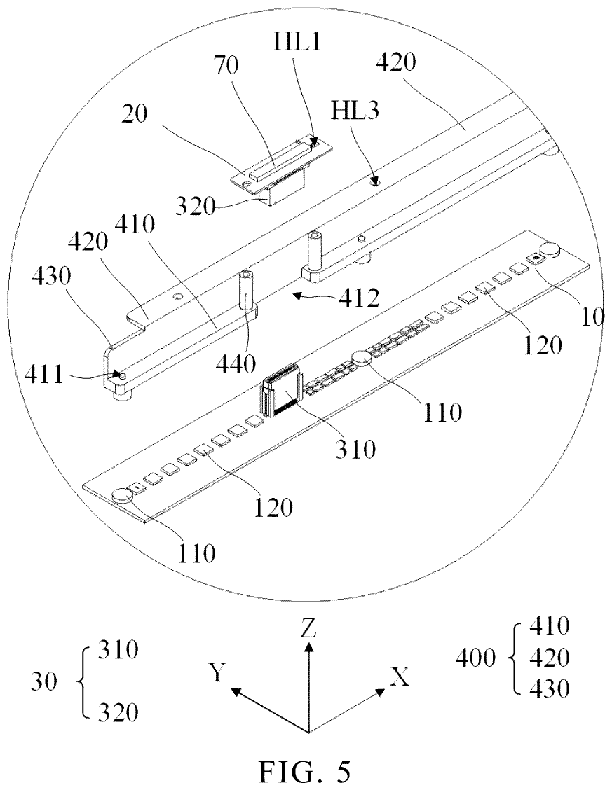

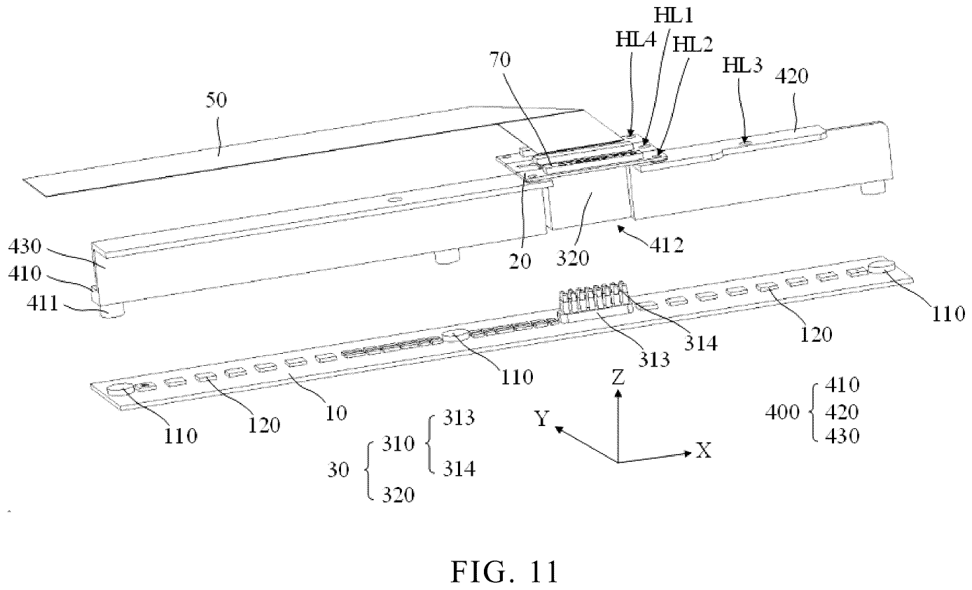

Referring to FIG. 4, FIG. 5, and FIG. 11, the connecting member 110 may be a magnetic metal pad and mainly configured to magnetically attract the light bars 10 to the adapter bracket 400. In order to facilitate the detachment of the light bars 10, one or more magnetic members 411 may be provided in the adapter bracket 400 in the embodiments to magnetically attract the light bars 10 on the adapter bracket 400. This simplifies the installation of the light bars 10 while ensuring that the light bars 10 are positioned separatable from the adapter bracket 400, thereby facilitating the disassembly of the light bars 10 to perform pre-maintenance of the light bars 10.

It should be noted that the separably positioning in the present disclosure may include detachable connection between the connecting member 110 and the magnetic member 411 or separable assembly of the connecting member 110 and the magnetic member 411. The detachable connection between the connecting member 110 and the magnetic member 411 may include magnetic connection or snap-fit between the connecting member 110 and the magnetic member 411.

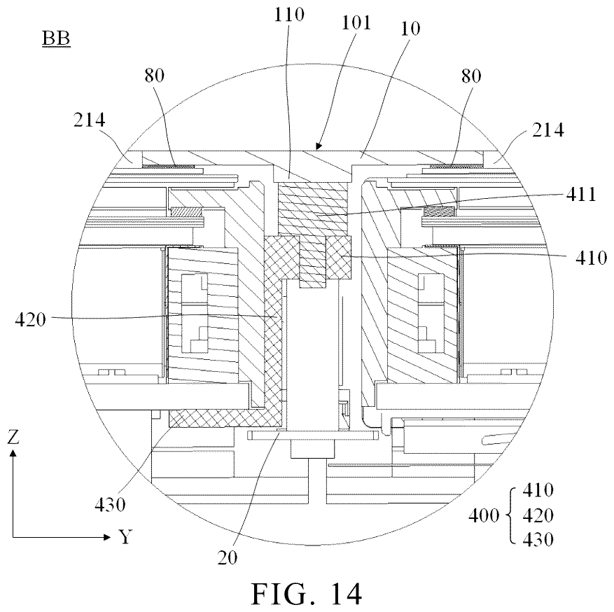

Referring to FIG. 14, the connecting member 110 and the magnetic member 411 may be disposed in contact with each other. Due to the magnetic attraction between the connecting member 110 and the magnetic member 411, the light bar 10 may be fastened in a modular structure within the splicing gap 500, thereby allowing the connecting member 110 and the magnetic member 411 to be detachably connected with each other.

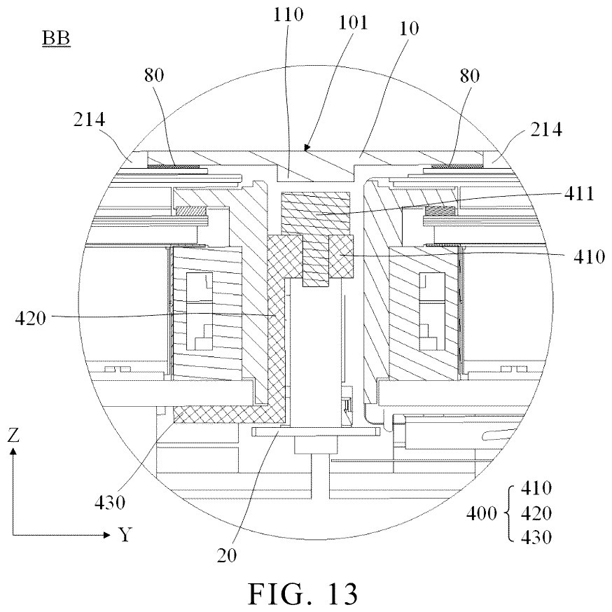

Referring to FIG. 13, there may be a gap between the connecting member 110 and the magnetic member 411, that is, the connecting member 110 and the magnetic member 411 may be spaced apart from each other. Since there is a magnetic attractive force between the connecting member 110 and the magnetic member 411, when the attractive force and a repulsive force between the connecting member 110 and the magnetic member 411 are equal, even if there is no contact between the connecting member 110 and the magnetic member 411, the light bar 10 can be fastened to the modular structure in the splicing gap 500.

In The Embodiments, The Gap May Range From 0.05 mm to 0.2 mm.

In the embodiments, in order to ensure a seamless fitting of the light bars 10 to the surface of the display devices 200, a position of the connecting member 110 corresponds to the splicing gap 500, that is, when fitting the light bar 10 to the surface of the display devices 200, the connecting member 110 may be embedded in the splicing gap 500.

In the embodiments, in order for the light bars 10 to minimize the splicing gap 500 as much as possible, a width of the splicing gap 500 in the present disclosure needs to be less than a width of the light bar 10 to realize seamless splicing of the display devices 200.

At the same time, a distance between the light-emitting element on the light bar 10 and an adjacent light-emitting element in the display devices 200 needs to be close to or equal to a distance between two adjacent light-emitting elements in the display devices 200, so as to realize the equal distance between two adjacent light-emitting elements at any position on the splicing display apparatus 100. Under the condition that a plurality of columns of light-emitting elements are provided on the light bar 10, a distance between two adjacent light-emitting elements on the light bar 10 needs to be close to or equal to the distance between two adjacent light-emitting elements in the display device 200, so as to ensure equal distance between any two adjacent light-emitting elements at any position on the splicing display apparatus 100, thereby achieving uniformity in the distribution of light-emitting elements.

In the embodiments, three connecting members 110 may be provided on one light bar 10, and the distances between two adjacent connecting members 110 may be equal or unequal. In the present disclosure, the distances between two adjacent connecting members 110 are unequal. The connecting member 110 may be fixedly connected to a back surface of the light bar 10 by an adhesive layer, such as 416 instant adhesive, or may be fixedly connected to the back surface of the light bar 10 by a welding material, such as soldering.

Referring to FIG. 4 to FIG. 6 and FIG. 9 to FIG. 11, the plurality of driving chips 120 may be disposed between adjacent connecting members 110, the first connector 310 may be disposed between two adjacent connecting members 110, and the first transmission member 30 and the plurality of driving chips 120 are sequentially arranged in the length direction of the light bar 10.

In the embodiments, the driving chip 120 is directly integrated onto the light bar 10, realizing the design of integrating the lamp and the driver. This eliminates the need to set an additional driving chip 120 on the back-light side 202 of the splicing display apparatus 100, thereby simplifying the structure of the supplementary lighting assembly 300. Meanwhile, each driving chip 120 may control one row or one column of light-emitting elements. Under the condition that a number of the driving chips 120 is sufficiently large, one driving chip 120 may control only one light-emitting element.

In the structures illustrated in FIG. 4 to FIG. 6 and FIG. 9 to FIGS. 11, 15 driving chips 120 are provided on one light bar 10. The first to eighth driving chips 120 are provided between a first connecting member 110 and a first transmission member 30, and the ninth to fifteenth driving chips 120 are provided between a second connecting member 110 and a third connecting member 110. That is, three connecting members 110, fifteen driving chips 120, and one first transmission member 30 may be sequentially arranged in the length direction of the light bar 10.

In the embodiments, other components, such as capacitors, may be provided on both sides of the second connecting member 110.

Referring to FIG. 4 to FIG. 6 and FIG. 9 to FIG. 11, the adapter bracket 400 may further include a bottom plate 420 and a support plate 430 connecting the top plate 410 and the bottom plate 420. The bottom plate 420 and the top plate 410 are arranged parallel to the light bar 10, and the support plate 430 is arranged perpendicular to the bottom plate 420 and the top plate 410.

In the embodiments, the top plate 410 protrudes from the support plate 430 in a first direction, and the bottom plate 420 protrudes from the support plate 430 in a second direction. Both the first direction and the second direction are parallel to the width direction Y of the light bar 10, and the first direction and the second direction are opposite to each other, that is, the adapter bracket 400 composed of the bottom plate 420, the support plate 430, and the top plate 410 is Z-shaped.

In the embodiments, the light bar 10 is detachably connected to the top plate 410. For example, at least two magnetic members 411 are provided on a side of the top plate 410 facing the light-emitting side 201, and the magnetic members 411 are fixed on the top plate 410. At the same time, one magnetic member 411 corresponds to one connecting member 110, and the connecting member 110 and the magnetic member 411 are magnetically attracted to each other.

In the structures illustrated in FIG. 4, FIG. 5 and FIG. 11, a number of the magnetic members 411 is the same as a number of the connecting members 110. For example, three connecting members 110 are provided on the light bar 10, and three magnetic members 411 corresponding to the three connecting members 110 are provided on the top plate 410. The magnetic attraction between the connecting member 110 and the magnetic member 411 allows for the detachable connection between the light bar 10 and the adapter bracket 400.

In the present disclosure, the adapter bracket 400 is provided on the back-light side 202 of each of the two adjacent display devices 200, and the light bar 10 and the adapter bracket 400 are magnetically connected by the connecting members 110 and the magnetic members 411 to realize detachable connection, thereby simplifying the installation of the light bar 10 and facilitating the maintenance of the overall supplementary lighting assembly 300.

In the embodiments, an end of the magnetic member 411 facing away from the light-emitting side 201 may be provided with a screw, and the top plate 410 may be provided with a fixing hole 413 screwed with the screw. An inner wall of the fixing hole 413 is provided with a thread, and the matching of the screw and the fixing hole 413 ensures that the magnetic member 411 is fixed to the top plate 410.

In the embodiments, an end surface of the magnetic member 411 on the side adjacent to the light-emitting side 201 may be provided with a groove corresponding to the connecting member 110, and the connecting member 110 may be embedded in the groove. When the connecting member 110 and the magnetic member 411 are magnetically attracted with each other, in order to prevent the light bar 10 from swinging in a plane, in which the length direction X and the width direction Y of the light bar 10 are located, on the adapter bracket 400, the groove is arranged to restrict the swinging of the connecting member 110 in the plane.

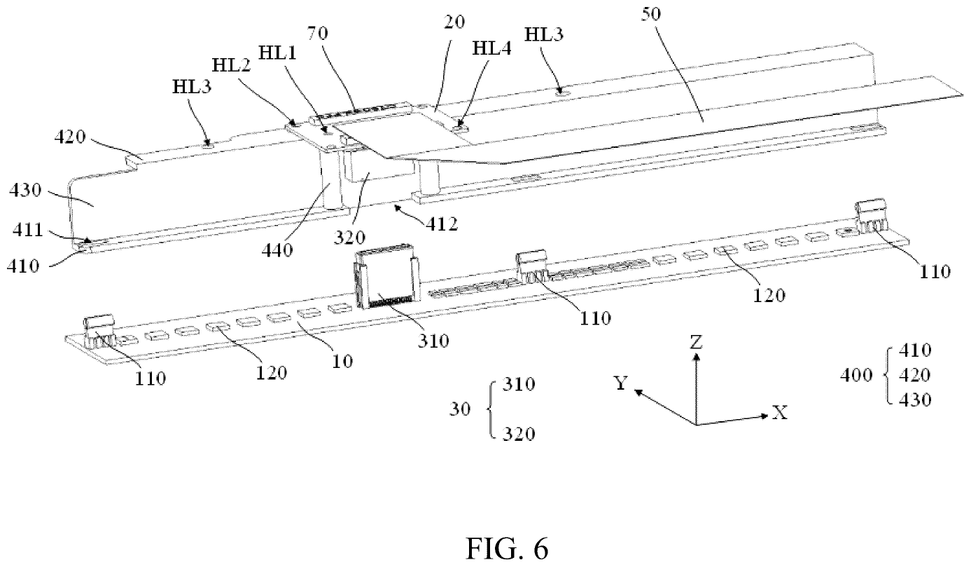

Referring to FIG. 6, at least two clasps 414 are provided on a side of the top plate 410 facing the light-emitting side 201. The clasps 414 are located on the top plate 410, one connecting member 110 corresponds to one clasp 414, and the connecting member 110 is snap-fitted with the clasp 414.

In the embodiments, the connecting member 110 may be a buckle, and the connecting member 110 is snap-fitted with the clasp 414, so that the light bar 10 is detachably connected to the top plate 410 of the adapter bracket 400. The following describes the technical proposals of the present disclosure using the connecting member 110 as a magnetic gasket.

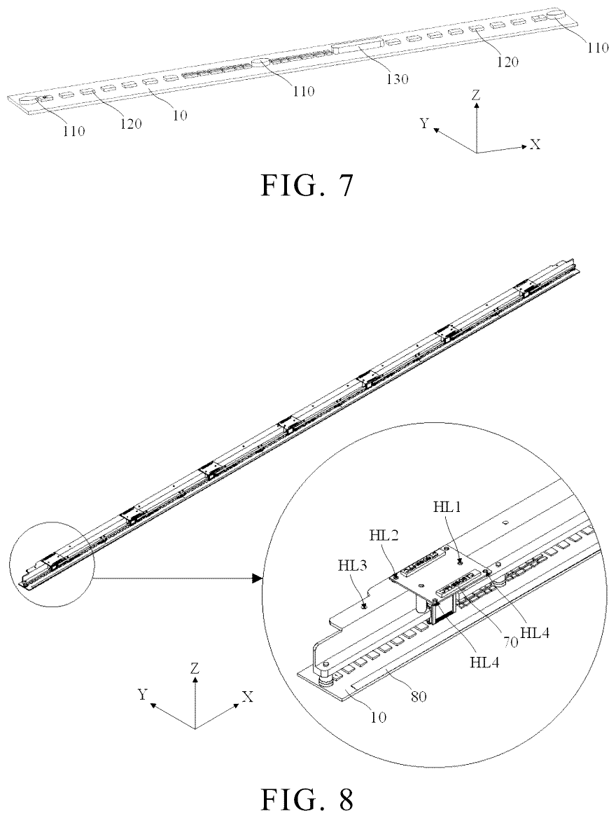

Referring to FIG. 7, the first transmission member may be a printed circuit board (not shown). An end of the first transmission member may be directly connected to a bonding member 130 of the light bar 10, and another end of the first transmission member is connected to the adapter plate. The first transmission member 30 is generally a flexible circuit board having a single-sided, double-sided, or multi-layer structure with different patterns, which is obtained by processing a flexible copper-clad laminate (FCCL) through chemical etching. Meanwhile, a first end of the first transmission member 30 is detachably connected to the side of the light bar 10 facing away from the light-emitting side 201, and a second end of the first transmission member 30 is detachably connected to the adapter plate 20.

Referring to FIG. 4 to FIG. 6 and FIG. 8 to FIG. 11, the first transmission member 30 may include a first connector 310 and a second connector 320 that are detachably connected with each other. The first connector 310 may be provided on the light bar 10 facing away from the light-emitting side 201. The first connector 310 extends toward the back-light side 202 and passes through the splicing gap 500. The second connector 320 may be provided on the side of the adapter plate 20 facing the light-emitting side 201.

It should be noted that, referring to FIG. 4 to FIG. 6 and FIG. 8 to FIG. 11, in the present disclosure, the first connector 310 is integrated on the light bar 10, the second connector 320 is integrated on the adapter plate 20, the detachable connection between the first connector 310 and the second connector 320 allows the light bar 10 and the adapter plate 20 to be detachably connected with each other. At the same time, the detachable connection between the adapter plate 20 and the second transmission member 50, and the detachable connection between the supplementary lighting assembly 300 and the adapter bracket 400 ensure that each component in the present disclosure is detachable, which facilitates the pre-maintenance and installation of each component.

It should be noted that at least one third connector 70 is further provided on the side of the adapter plate 20 facing away from the light-emitting side 201, and a first end of the second transmission component 50 may be electrically connected to one of the third connectors 70 on the adapter plate 20.

It should be noted that the second transmission member 50 may be a flexible flat cable, and the second transmission member 50 generally utilizes upper and lower insulating foil films with a flat copper foil sandwiched therebetween.

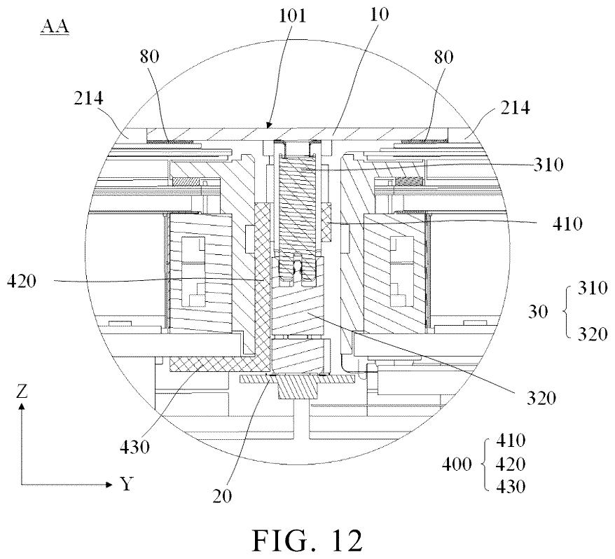

It should be noted, referring to FIG. 12, the first connector 310, the light bar 10, and the adapter plate 20 are vertically arranged, and the first connector 310 and the second connector 320 are separated from the two adjacent display devices 200, that is, the first connector 310 and the second connector 320 may be arranged in the splicing gap 500. In the embodiments, since a distance between the controller 60 and the adapter plate 20 is small, the longer second transmission member 50 may be bent and provided, and two adjacent second transmission members 50 may be partially overlapped.

It should be noted that positions of the cross-section AA and the cross-section BB in FIG. 1 are for illustrative purposes only. The structure in FIG. 12 is a schematic view in which the cross-section in this direction passes through the first connector 310 and the second connector 320, and FIGS. 13 and 14 are schematic views in which the cross-section in this direction passes through the connecting member 110 and the magnetic member 411. Additionally, FIG. 12 to FIG. 14 are not final structural diagrams, and are merely schematic diagrams provided to facilitate the description of the structure.

Referring to FIG. 4 to FIG. 6 and FIG. 8 to FIG. 10, the first connector 310 and the second connector 320 may be signal connectors, such as KEL connectors. The first connector 310 may be a female socket of a signal connector, the second connector 320 may be a male socket of the signal connector, and the first connector 310 and the second connector 320 may be snap-fitted with each other.

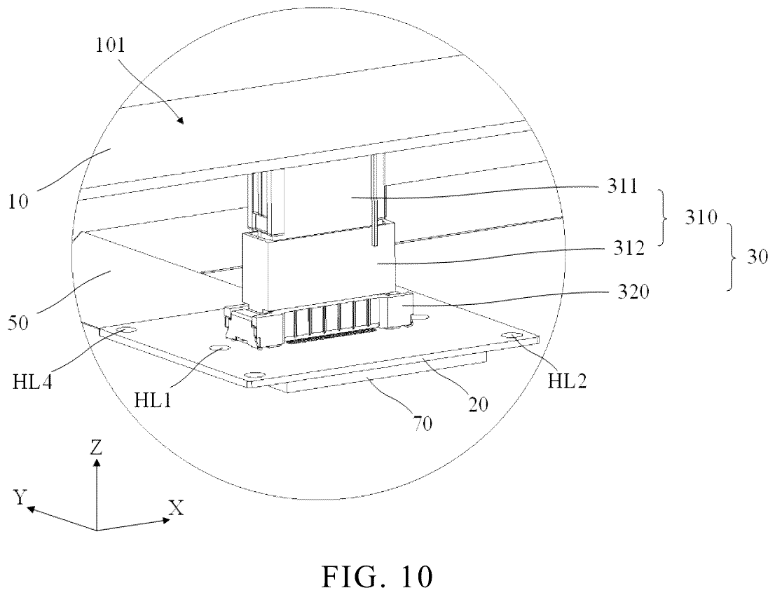

When the light bar is fixedly connected to the adapter bracket, due to alignment tolerances, the first connector 310 and the second connector 320 cannot be accurately snap-fitted with each other. In the structure illustrated in FIG. 10, the first connector 310 and the second connector 320 are movably connected in the width direction Y of the light bar 10 and the length direction X of the light bar 10. In the embodiments, an area of the second connector 320 is greater than an area of the first connector 310, that is, the first connector 310 can move on the second connector 320 in the width direction Y of the light bar 10 and the length direction X of the light bar 10, so as to solve the technical problem that the first connector 310 and the second connector 320 cannot be accurately snap-fitted with each other.

Meanwhile, in the structure illustrated in FIG. 10, the first connector 310 and the second connector 320 are telescopically connected in the thickness direction Z of the light bar 10. For example, the first connector 310 and the second connector 320 need not be completely snapped, and as long as the first connector 310 and the second connector 320 are partially snapped, the connection between the first connector 310 and the second connector 320 can be realized to reserve an alignment tolerance in the thickness direction Z of the light bar 10.

In the embodiments, the first connector 310 moves up and down as a whole in the thickness direction Z of the light bar 10. Alternatively, the first connector 310 may include a first sub-element 311 fixedly connected to the light bar 10 and a second sub-element 312 connected to the first sub-element 311. The second sub-element 312 is snap-fitted with the second connector 320, and the second sub-element 312 may be telescopically connected with the first sub-element 311 along the thickness direction Z of the light bar 10, that is, the second sub-element 312 slides along the thickness direction Z of the light bar 10, leaving the tolerance in the thickness direction Z of the light bar 10, so as to solve the technical problem that the first connector 310 and the second connector 320 cannot be accurately snap-fitted with each other.

In the embodiments, a distance at which the first connector 310 is movable in the thickness direction Z of the light bar 10 may range from 1 mm to 5 mm.

Referring to FIG. 11, the first transmission member 30 may be a probe connector, the first connector 310 may further include a base 313 and a plurality of connecting pins 314 provided on the base 313. The second connector 320 may include a plurality of connecting ports (not shown). One connecting pin 314 is embedded in one connection interface, and a number of the connecting ports may be greater than or equal to a number of the connecting pins 314. Meanwhile, similar to FIG. 10, in the embodiments, the first connector 310 and the second connector 320 are movably connected in the length direction X, the width direction Y, and the thickness direction Z of the light bar 10.

In the following embodiments, that the first transmission member 30 includes the first connector 310 and the second connector 320 is taken as an example for explanation.

Since the top plate 410 is provided with a plurality of magnetic members 411 corresponding to the plurality of connecting members 110, and the connecting members 110, the first connectors 310, and the plurality of driving chips 120 are sequentially arranged in the length direction of the light bar 10, orthographic projections of the connecting members 110, the first connectors 310, and the plurality of driving chips 120 on the top plate 410 may all be located in the top plate 410. However, as the first connector 310 needs to be connected to the second connector 320 located on a side of the bottom plate 420, the arrangement of the top plate 410 may interfere with the first connector 310.

Referring to FIG. 5, FIG. 6 and FIG. 11, at least one notch 412 is formed on the top plate 410, and the first transmission member 30 is connected to the corresponding adapter plate 20 through the notch 412.

In the embodiments, a number of the notches 412 may be the same as the number of the first connectors 310, and a size of the notch 412 in the length direction of the light bar 10 may be greater than a size of the first connector 310 in the length direction of the light bar 10. The arrangement of the notch 412 allows the first connector 310 to pass through the notch 412 and extend toward the side away from the light bar 10, or the second connector 320 to pass through the notch 412 and extend toward the side of the light bar 10.

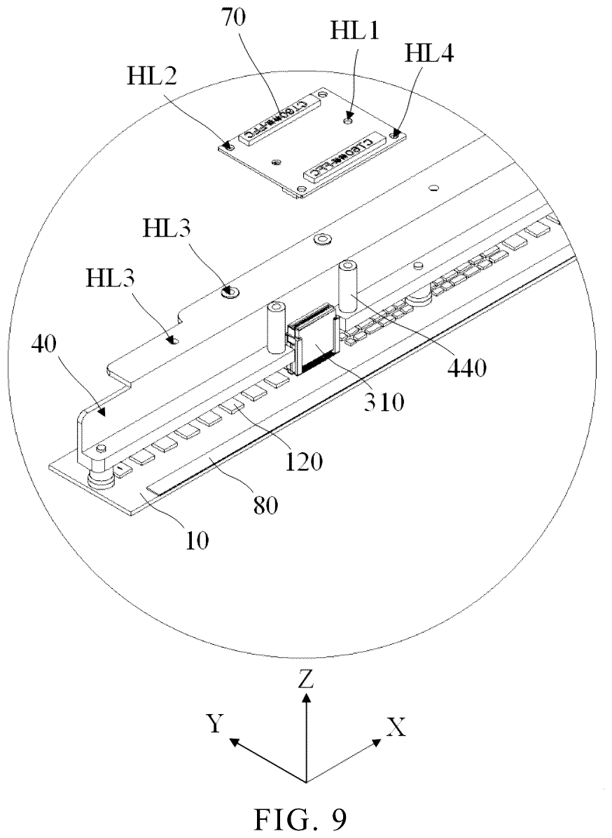

Referring to FIG. 4 to FIG. 6, FIG. 9, and FIG. 11, fixing posts 440 are provided on the side of the top plate 410 facing away from the light-emitting side 201. The fixing posts 440 are provided on both sides of the notch 412, the fixing posts 440 extend in a direction from the top plate 410 to the bottom plate 420, and the adapter plate 20 is detachably connected with the fixing posts 440.

In the structures illustrated in FIG. 4 to FIG. 6, FIG. 10 and FIG. 11, the third connector 70 is provided on the adapter plate 20, and the third connector 70 is electrically connected to the second connector 320. At the same time, the adapter plate 20 is further provided with two first through holes HL1, and the two first through holes HL1 may be located on both sides of the third connector 70. The first through holes HL1 correspond to the fixing post 440, the fixing post 440 is provided with a threaded hole inside, and a fastener may pass through the first through hole HL1 and be screwed with the threaded hole in the fixing post 440, so as to fix the adapter plate 20 on the adapter bracket 400.

In the embodiments, in order to avoid interference between the adapter plate 20 and the bottom plate 420, a distance between a surface of the fixing post 440 on the side facing away from the light-emitting side 201 and the light bar 10 needs to be greater than a distance between a surface of the bottom plate 420 on the side facing away from the light-emitting side 201 and the light bar 10, that is, the fixing post 440 needs to protrude from the surface of the bottom plate 420 on the side facing away from the light-emitting side 201.

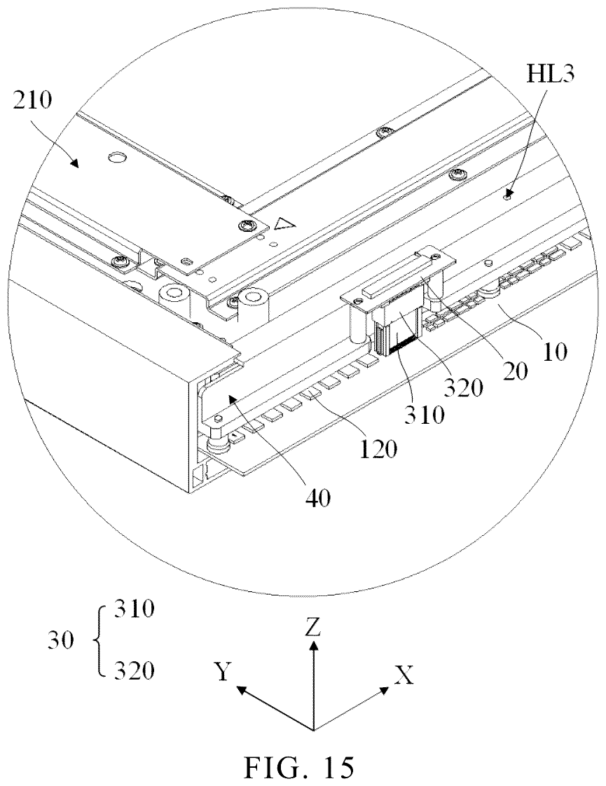

In the embodiments, the bottom plate 420 is further provided with a plurality of third through holes HL3, threaded holes corresponding to the third through holes HL3 are provided on the back-light side 202 of one of the adjacent two display devices 200, and a fastener can pass through the third through hole HL3 and be screwed with the threaded hole in the display device 200 to fix the adapter bracket 400 on the display device 200. For example, the splicing display apparatus 100 includes a first display device 210 and a second display device 220, the first display device 210 partially overlaps with the bottom plate 420, the controller 60 is fixed to the second display device 220, and the bottom plate 420 may be fixedly connected to the first display device 210, as illustrated in FIG. 15.

In the embodiments, since the threaded holes are provided on the top plate 410, and in order to ensure the fixing force between the magnetic member 411 and the top plate 410, the threaded hole needs to have a certain depth. Meanwhile, the bottom plate 420 only needs to be provided with the through holes to allow the fastener to pass through the through hole and be fixedly connected to one of the two display devices 200. Therefore, a thickness of the top plate 410 needs to be greater than a thickness of the bottom plate 420.

Referring to FIG. 8, FIG. 9 and FIG. 11, the adapter plate 20 may be provided with two third connectors 70, and the second transmission member 50 may be connected to one of the two third connectors 70 according to the position of the controller 60. At the same time, two first through holes HL1 are provided between the two third connectors 70, and fasteners can pass through the first through holes HL1 and be screwed with threaded holes in the fixing posts 440 to fix the adapter plate 20 on the fixing posts 440.

Referring to FIG. 8, FIG. 9 and FIG. 11, the third connector 70 adjacent to the first display device 210 is provided with two second through holes HL2 on both sides along the length direction of the light bar 10. The third connector 70 adjacent to the second display device 220 is provided with two fourth through holes HL4 on both sides along the length direction of the light bar 10. The second through holes HL2 correspond to the third through holes HL3 on the bottom plate 420, and the fasteners can pass through the second through holes HL2 and the third through holes HL3 and thread into the threaded holes inside the first display device 210 to secure the adapter plate 20 and the adapter bracket 400 onto the first display device 210. Meanwhile, fasteners can pass through the fourth through holes HL4 and thread into the threaded holes inside the second display device 220 to secure the adapter plate 20 onto the second display devices 220.

In addition, the third through hole HL3 may be replaced with a threaded hole, that is, the fastener may be threaded through the second through hole HL2 with the threaded hole on the bottom plate 420 to fix the adapter plate 20 on the bottom plate 420.

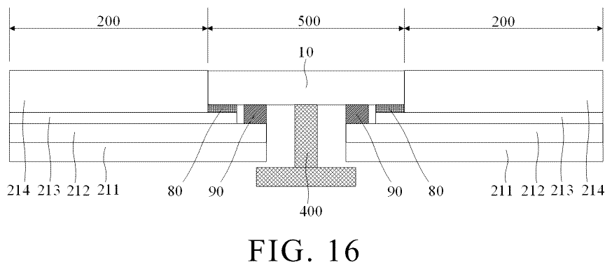

Referring to FIG. 16, each display device 200 may include a backlight module 211, a display panel 212 disposed on the backlight module 211, and an encapsulation cover plate 214 disposed on the display panel 212. The light bar 10 and a part of the adapter bracket 400 may be located in the splicing gap 500. A surface of the light bar 10 on the side facing the light-emitting side 201 and a surface of the encapsulation cover plate 214 on the side facing the light-emitting side 201 are on the same plane.

In the embodiments, the light bar 10 may overlap with the display panel 212, and at the same time, a thickness of the light bar 10 may be the same as a thickness of the encapsulation cover plate 214, so that a surfaces of the light bar 10 and a surfaces of the encapsulation cover plate 214 facing the light-emitting side 201 are located on the same plane, ensuring the flatness of a light-emitting surface of the spliced display devices 200.

Referring to FIG. 16, since an optical film layer is provided on the display panel 212, in order to prevent the optical film layer on the display panel 212 from being damaged due to the movement of the light bar 10, in the present disclosure, an area of an adhesive layer 213 between the display panel 212 and the encapsulation cover plate 214 is ensured to be greater than an area of the encapsulation cover plate 214, that is, the light bar 10 can overlap on the adhesive layer 213 beyond the boundary of the encapsulation cover plate 214. The adhesive layer 213 is a flexible material, which can prevent the light bar from damaging the optical film layer on the display panel 212.

In the embodiments, the material of adhesive layer 213 may be optical adhesive.

Since the light bar 10 directly overlaps on the adhesive layer 213, the light bar 10 is adhered to the adhesive layer 213. Since he adhesive layer 213 has strong adhesiveness, the light bar 10 and the adhesive layer 213 are difficult to separate during disassembly or pre-maintenance of the light strip 10, and at the same time, the residual adhesive layer 213 may cause dark lines to appear at the edges of the display devices 200, thereby affecting the display quality of the display devices 200.

In the embodiments, the splicing display apparatus 100 further includes one or more anti-adhesion members 80. The anti-adhesion member 80 is disposed on a side of the adhesive layer 213 away from the display panel 212, and the anti-adhesion member 80 is disposed in an area of the adhesive layer 213 corresponding to the light bar 10.

In the embodiments, the light bar 10 at least partially overlaps with the display panels 212 in two adjacent display devices 200, and the anti-adhesion member 80 may be provided between the light bar 10 and the corresponding display panel 212. The arrangement of the anti-adhesive member 80 can isolate the adhesive layer 213 from the light bar 10, so that there is no adhesive force between the light bar 10 and the adhesive layer 213, and the light bar 10 and the adhesive layer 213 are easily separated during disassembly or pre-maintenance of the light strip 10, thereby avoiding the appearance of residual adhesive.

In the embodiments, the material of the anti-adhesion member 80 may be a plastic such as polyethylene terephthalate (PET), polyethylene (PE), polyvinyl chloride (PVC), polypropylene (PP), polystyrene (PS), polylactic acid (PLA), polycarbonate fiber (PC), acrylic (PMMA), etc.

It should be noted that the anti-adhesion member 80 shown on the light bar 10 in FIG. 8 and FIG. 9 only indicates that the anti-adhesion member 80 may be located on the side of the light bar 10 facing away from a light-emitting direction, and the anti-adhesion member 80 is not adhered to the surface of the light bar 10 facing away from the light-emitting direction.

Referring to FIG. 16, a buffer member 90 may also be provided between the display panel 212 and the light bar 10. The buffer member 90 is located in the splicing gap 500 and away from the anti-adhesion member 80. The buffer member 90 may be configured to support the light bar 10.

In the embodiments, a distance from an upper surface of the encapsulation cover plate 214 to an upper surface of the display panel 212 may be equal to a sum of the thickness of the light bar 10 and a thickness of the buffer member 90. Since the buffer member 90 is disposed between the light bar 10 and the display panel 212, and the encapsulation cover plate 214 is disposed on the display panel 212, in order to ensure the upper surface of the encapsulation cover plate 214 to be flush with the upper surface of the light bar 10, a distance from the upper surface of the encapsulation cover plate 214 to an upper surface of the display panel 212 needs to be equal to the sum of the thickness of the light bar 10 and the thickness of the buffer member 90.

It should be noted that the distance from the surface of the encapsulation cover plate 214 on the side facing away from the display panel 212 to the display panel 212 is equal to the sum of the thickness of the light bar 10 and the thickness of the buffer member 90, this may include not only the case where they are are completely equal but also the case where they are substantially equal within an allowable error range. For example, the distance from the surface of the encapsulation cover plate 214 on the side facing away from the display panel 212 to the display panel 212 may be slightly greater than the sum of the thickness of the light bar 10 and the thickness of the buffer member 90, or the distance from the surface of the encapsulation cover plate 214 on the side facing away from the display panel 212 to the display panel 212 may be slightly less than the sum of the thickness of the light bar 10 and the thickness of the buffer member 90.

In the embodiments, the material of the buffer member 90 may be silicone gel or foam adhesive. The silicone gel or foam adhesive has a certain elasticity, and when the silicone gel or foam adhesive is located between the display panel 212 and the light bar 10, a buffer can be formed, the damage to the display panel 212 during the installation and disassembly process can be reduced, and the stability of the connection between the light bar 10 and the display panel 212 can be improved. At the same time, a thickness of the silicone gel or foam adhesive is variable when subjected to an external force, so that it is convenient to adjust the flatness of the encapsulation cover plate 214 and the light bar 10, so that the upper surface of the light bar 10 is flush with the upper surface of the encapsulation cover plate 214.

Referring to FIG. 16, the sum of the thickness of the adhesive layer 213 and the thickness of the encapsulation cover plate 214 may be equal to the sum of the thickness of the buffer member 90 and the thickness of the light bar 10. When the adhesive layer 213 is disposed between the encapsulation cover plate 214 and the display panel 212, in order to ensure that the upper surface of the encapsulation cover plate 214 is flush with the upper surface of the light bar 10, the sum of the thickness of the adhesive layer 213 and the thickness of the encapsulation cover plate 214 needs to be equal to the sum of the thickness of the buffer member 90 and the thickness of the light bar 10.

In the embodiments, “equal” not only includes cases where the two values are completely identical but also includes cases where the two values are substantially equal within an allowable error range. For example, the sum of the thickness of the adhesive layer 213 and the thickness of the encapsulation cover plate 214 is slightly greater than the sum of the thickness of the buffer member 90 and the thickness of the light bar 10, or the sum of the thickness of the adhesive layer 213 and the thickness of the encapsulation cover plate 214 is slightly less than the sum of the thickness of the buffer member 90 and the thickness of the light bar 10.

Meanwhile, the thickness of the buffer member 90 may be greater than or equal to the sum of the thickness of the anti-adhesion member 80 and the thickness of the adhesive layer 213. When the thickness of the buffer member 90 is equal to the sum of the thickness of the anti-adhesion member 80 and the thickness of the adhesive layer 213, the light bar 10 is in contact with both the buffer member 90 and the anti-adhesion member 80. When the thickness of the buffer member 90 is equal to the sum of the thickness of the anti-adhesion member 80 and the thickness of the adhesive layer 213, the light bar 10 is in contact with the buffer member 90, but there is a gap between the light bar 10 and the anti-adhesion member 80, so in the present disclosure, the flatness of the light bar 10 and the encapsulation cover plate 214 on the light-emitting side 201 can be adjusted by adjusting the thickness of the buffer member 90.

In the embodiments, the thickness of the anti-adhesion member 80 needs to be less than a preset value, that is, the sum of the thickness of the anti-adhesion member 80 and the thickness of the adhesive layer 213 is less than or equal to the thickness of the buffer member 90, so as to prevent the thickness of the anti-adhesion member 80 from being too large to jack up the light bar 10 after the display devices 200 are assembled, resulting in the upper surface of the light bar 10 being not flush with the upper surface of the encapsulation cover plate 214.

In the embodiments, when the thickness of the anti-adhesion member 80 is less than the preset value, a height of the upper surface of the light bar 10 can be adjusted only by adjusting the thickness of the buffer member 90, so that the upper surface of the light bar 10 is flush with the upper surface of the encapsulation cover plate 214.

In the structure of FIG. 16, an orthographic projection of the anti-adhesion member 80 on the display panel 212 and an orthographic projection of the buffer member 90 on the display panel 212 may both be located within a range of an orthographic projection of the light bar 10 on the display panel 212, that is, the anti-adhesion member 80 and the buffer member 90 may both be located in the splicing gap 500. When the user views the display devices 200 from the front, dark lines or dark spots are avoided in the area where the anti-adhesion members 80 and the buffer members 90 of the display panels 212 are located, and the display effect of the display panels 212 is improved.

In the embodiments, the thickness of the encapsulation cover plate 214 may range from 1.5 mm to 2.2 mm, the thickness of the light bar 10 may range from 1.0 mm to 1.5 mm, the thickness of the buffer member 90 may range from 0.3 mm to 1.7 mm, the thickness of the anti-adhesion member 80 may range from 0.1 mm to 1.4 mm, and the thickness of the adhesive layer 213 may range from 0.3 mm to 0.5 mm. For example, the value of the thickness of the adhesive layer 213 may be one of 0.30 mm, 0.32 mm, 0.34 mm, 0.36 mm, 0.38 mm, 0.40 mm, 0.42 mm, 0.44 mm, 0.46 mm, 0.48 mm, and 0.50 mm.

It should be noted that in the present disclosure, the upper surface of the display panel 212 refers to the surface of the display panel 212 that is adjacent to the light-emitting side 201, the upper surface of the light bar 10 refers to the surface of the light bar 10 that is adjacent to the light-emitting side 201, and the upper surface of the encapsulation cover plate 214 refers to the surface of the encapsulation cover plate 214 that is adjacent to the light-emitting side 201.

Referring to FIG. 3 to FIG. 14, the present disclosure also provides a light-emitting module 600, which includes an adapter bracket 400 and a supplementary lighting assembly 300. The supplementary lighting assembly 300 is positioned separatable from the adapter bracket 400. The supplementary lighting assembly 300 may include a light bar 10, an adapter plate 20, a first connector 310, and a second connector 320.

In the embodiments, the adapter plate 20 is fixed to the side of the adapter bracket 400 away from a light-emitting surface 101 of the light bar 10, the first connector 310 is provided on the side of the light bar 10 facing away from the light-emitting surface 101, the second connector 320 is provided on the side of the adapter plate 20 facing the light-emitting surface 101 of the light bar 10, and the first connector 310 and the second connector 320 are detachably connected with each other.

In the embodiments, a plurality of light-emitting elements are provided on the side of the light bar 10 facing the light-emitting surface 101, and a plurality of driving chips 120 are provided on the side of the light bar 10 facing away from the light-emitting surface 101, and the driving chips 120 are configured to control the plurality of light-emitting elements.

It should be noted that the first connector 310 and the second connector 320 constitute a first transmission member 30, and the first transmission member 30 can be replaced with the structures shown in FIG. 7 and FIG. 11.

In the present disclosure, the driving chips 120 are provided on the light bar, and the light bar 10 is positioned separatable from the adapter bracket 400, so that the light bar 10 in the supplementary lighting assembly can be positioned separatable from the adapter bracket 400, simplifying the installation and disassembly of the light bar 10, and facilitating the pre-maintenance of the light bar 10 integrated with both the lamp and the driver.

In the embodiments, the supplementary lighting assembly 300 further includes a second transmission member 50 and a controller 60. A first end of the second transmission member 50 is detachably connected to the adapter plate 20, and a second end of the second transmission member 50 is electrically connected to the controller 60.

In the light-emitting module of the present disclosure, at least two connecting members 110 are provided on the side of the light bar 10 facing away from the light-emitting surface 101, and the at least two connecting members 110 are positioned separatable from the adapter bracket 400. For example, the connecting member 110 may be a magnetic spacer in FIG. 4 and FIG. 5, and the connecting member 110 may be a buckle in FIG. 6.

In the above-described embodiments, the description of each embodiment has its own emphasis, and the parts not detailed in one embodiment can be referred to the relevant descriptions of other embodiments.

The splicing display apparatus and the light-emitting module provided in embodiments of the present disclosure have been described in detail above, and the principle and implementation mode of the present disclosure have been described herein by applying specific examples, and the description of the above embodiments is only for helping to understand the technical proposals and core ideas of the present disclosure. Those skilled in the art should understand that the technical proposals described in the above embodiments can still be modified, or some technical features can be equivalently replaced. However, these modifications or substitutions do not cause the essence of the corresponding technical proposals to deviate from the scope of the technical proposals of each embodiment of the present disclosure.

1. A splicing display apparatus, comprising:
at least two display devices, a splicing gap being formed between two adjacent display devices of the display devices;
an adapter bracket located on a back-light side of each of the two adjacent display devices, and the adapter bracket being configured to be detachably connected to at least one of the two adjacent display devices; and
a supplementary lighting assembly configured to be positioned separatable from the adapter bracket, wherein the supplementary lighting assembly comprises a light bar located on a light-emitting side of each of the two adjacent display devices, and the light bar covers the splicing gap; and
wherein a plurality of light-emitting elements are provided on a side of the light bar facing the light-emitting side, a plurality of driving chips are provided on a side of the light bar facing away from the light-emitting side, and separably positioning parts of the adapter bracket and the supplementary lighting assembly are located in an orthographic projection of a plane where the splicing gap is located.

2. The splicing display apparatus according to claim 1, wherein at least two connecting members are provided on the side of the light bar facing away from the light-emitting side, and the at least two connecting members are located in the splicing gap;
the adapter bracket comprises a top plate, at least two magnetic members are provided on a side of the top plate facing the light-emitting side, and the magnetic members are fixed to the top plate; and
each of the magnetic members corresponds to one of the connecting members, a magnetic attractive force is formed between each of the connecting members and a corresponding one of the magnetic members, and each of the connecting members and the corresponding one of the magnetic members are spaced apart from each other.

3. The splicing display apparatus according to claim 1, wherein at least two connecting members are provided on the side of the light bar facing away from the light-emitting side, and the at least two connecting members are located in the splicing gap;
the adapter bracket comprises a top plate, and the at least two connecting members are configured to be detachably connected to the top plate.

4. The splicing display apparatus according to claim 3, wherein at least two magnetic members are provided on a side of the top plate facing the light-emitting side, and the magnetic members are fixed to the top plate; and
wherein each of the magnetic members corresponds to one of the connecting members, each of the connecting members and a corresponding one of the magnetic members are magnetically attracted to each other, and each of the connecting members is disposed in contact with the corresponding one of the magnetic members.

5. The splicing display apparatus according to claim 3, wherein at least two clasps are provided on a side of the top plate facing the light-emitting side, and the clasps are provided on the top plate; and
wherein each of the connecting members corresponds to one of the clasps, and each of the connecting members is snap-fitted with a corresponding one of the clasps.

6. The splicing display apparatus according to claim 1, wherein the supplementary lighting assembly further comprises a first transmission member disposed in the splicing gap, a first end of the first transmission member is electrically connected to the side of the light bar facing away from the light-emitting side, and a second end of the first transmission member extends toward the back-light side of the display device and passes through the splicing gap.

7. The splicing display apparatus according to claim 6, wherein the supplementary lighting assembly further comprises an adapter plate fixed to a side of the adapter bracket away from the light-emitting side; and
wherein the first transmission member comprises a first connector and a second connector, the first connector is provided on the side of the light bar facing away from the light-emitting side, the second connector is provided on a side of the adapter plate facing the light-emitting side, and the first connector and the second connector are configured to be detachably connected with each other.

8. The splicing display apparatus according to claim 7, wherein the first connector and the second connector are configured to be movably connected with each other in a width direction of the light bar and a length direction of the light bar.

9. The splicing display apparatus according to claim 8, wherein the first connector and the second connector are configured to be telescopically connected with each other in a thickness direction of the light bar.

10. The splicing display apparatus according to claim 7, wherein the first connector comprises a plurality of connecting pins, the second connector comprises a plurality of connecting ports, each of the connecting pins is embedded in a corresponding one of the connecting ports, and a number of the connecting ports is greater than or equal to a number of the connecting pins.

11. The splicing display apparatus according to claim 6, wherein the supplementary lighting assembly further comprises an adapter plate fixed to a side of the adapter bracket away from the light-emitting side, the first end of the first transmission member is configured to be detachably connected to the side of the light bar facing away from the light-emitting side, and the second end of the first transmission member is configured to be detachably connected to the adapter plate.

12. The splicing display apparatus according to claim 7, wherein the top plate is provided with at least one notch, and the first transmission member is connected to the adapter plate through the notch.

13. The splicing display apparatus according to claim 12, wherein fixing posts are provided on a side of the top plate facing away from the light-emitting side, the fixing posts are arranged on both sides of the notch, the fixing posts extend in a direction from the light bar to the top plate, and the adapter plate is configured to be detachably connected with the fixing posts.

14. The splicing display apparatus according to claim 13, wherein the adapter bracket further comprises a bottom plate and a support plate connecting the top plate and the bottom plate, the bottom plate and the top plate are arranged parallel to the light bar, and the support plate is arranged perpendicular to the bottom plate and the top plate.

15. The splicing display apparatus according to claim 14, wherein the adapter plate is provided with a first through hole and a second through hole, a fastener is provided to pass through the first through hole and be connected to the fixing post, and another fastener is provided to pass through the second through hole and be fixedly connected to the bottom plate or one of the display devices.

16. The splicing display apparatus according to claim 7, wherein the supplementary lighting assembly further comprises:
a second transmission member located on the back-light side of the two adjacent display devices, wherein a first end of the second transmission member and the adapter plate are configured to be detachably connected with each other; and
a controller fixed to the back-light side of one of the two adjacent display devices, wherein a second end of the second transmission member is electrically connected to the controller.

17. The splicing display apparatus according to claim 1, wherein each of the display devices comprises a backlight module, a display panel disposed on the backlight module, and an encapsulation cover plate disposed on the display panel; and
wherein a surface of the light bar facing the light-emitting side and a surface of the encapsulation cover plate facing the light-emitting side are located on a same plane.

18. The splicing display apparatus according to claim 17, wherein each of the display devices further comprises an adhesive layer, and the adhesive layer is disposed between the display panel and the encapsulation cover plate; and
the splicing display apparatus further comprises an anti-adhesion member, the anti-adhesion member is disposed on a side of the adhesive layer away from the display panel, and the anti-adhesion member is disposed in an area corresponding to the adhesive layer and the light bar.

19. A splicing display apparatus, comprising:
at least two display devices, a splicing gap being formed between two adjacent display devices of the display devices;
an adapter bracket located on a back-light side of each of the two adjacent display devices, the adapter bracket being connected to at least one of the two adjacent display devices; and
a supplementary lighting assembly positioned separatable from the adapter bracket, wherein the supplementary lighting assembly comprises a light bar located on a light-emitting side of each of the two adjacent display devices, and two sides of the light bar overlap with the two adjacent display devices, respectively, and cover at least a part of the splicing gap; and
wherein a plurality of light-emitting elements are provided on a side of the light bar facing the light-emitting side, a plurality of driving chips are provided on a side of the light bar facing away from the light-emitting side, and separably positioning parts of the adapter bracket and the supplementary lighting assembly are located in an orthographic projection of a plane where the splicing gap is located.

20. A light-emitting module, comprising an adapter bracket and a supplementary lighting assembly, the supplementary lighting assembly being positioned separatable from the adapter bracket, and the supplementary lighting assembly comprising:
a light bar comprising a light-emitting surface;
an adapter plate fixed on a side of the adapter bracket away from the light-emitting surface;
a first connector provided on a side of the light bar facing away from the light-emitting surface; and
a second connector provided on a side of the adapter plate facing the light-emitting surface, wherein the first connector and the second connector are configured to be detachably connected with each other; and
wherein a plurality of light-emitting elements are provided on a side of the light bar facing the light-emitting surface, and a plurality of driving chips are provided on the side of the light bar facing away from the light-emitting surface.
